(19) United States
(12) Patent Application Publication
(10) Pub. No.: US 2012/0076510 A1
(43) Pub. Date: Mar. 29, 2012

(54) IMAGE FORMING APPARATUS AND IMAGE FORMING SYSTEM

(75) Inventors: Kyoichi MIZUNO, Tokyo (JP); Tarou MIYAMOTO, Toyokawa-shi (JP); Kunihiro KAWACHI, Tokyo (JP); Yusuke KAWANAGO, Tokyo (JP)

(73) Assignee: KONICA MINOLTA BUSINESS TECHNOLOGIES, INC., Tokyo (JP)

(21) Appl. No.: 13/235,670

(22) Filed: Sep. 19, 2011

(30) Foreign Application Priority Data
Sep. 27, 2010 (JP) 2010-214909

(51) Int. Cl. G03G 15/20

(52) U.S. Cl. 399/12

(57) ABSTRACT

An image forming apparatus including: an image formation section for forming a toner image based on image data on a recording medium; a first fixing device for fixing the toner image formed by the image formation section; an accommodation section for storing the first fixing device or a second fixing device having different specifications than those of the first fixing device; and a peripheral member arranged on the periphery of the accommodation section to operate synchronously with the first fixing device or second fixing device; wherein, when the first fixing device accommodated in the accommodation section has been replaced by the second fixing device, a status of the peripheral member is switched in conformity to specifications of the second fixing device.

### RELATED APPLICATION

This application is based on Japanese Patent Application No. 2010-214909 filed on Sep. 27, 2010 in Japanese Patent Office, the entire content of which is hereby incorporated by reference.

### BACKGROUND OF THE INVENTION

1. Technical Field

The present invention relates to an image forming apparatus and image forming system, particularly to an image forming apparatus and image forming system wherein a fixing device can be replaced.

2. Prior Art

To meet the various requirements of paper such as special paper in recent years, an image forming apparatus using an electrophotographic process such as a photocopier and printer is provided with a special-purpose fixing device capable of meeting varied requirements of special sheets of paper, in addition to the conventional general-purpose fixing device. When special sheets of paper are to be used, a fixing device is replaced by a special-purpose fixing device.

For example, the Unexamined Japanese Patent Application Publication No. 2004-086109 discloses an image output procedure that produces any of two types of images having different forms of glossiness by replacing two types of fixing devices using silicone oils of different viscosity.

Further, for example, the Unexamined Japanese Patent Application Publication No. 2007-065598 discloses an image forming apparatus capable of customizing the operation specifications for image formation in conformity to the requirements of use by a combination between the sub-system and platform having part of the image forming functions of an image forming device, fixing device and others.

However, when the fixing device has been replaced by a special-purpose fixing device, the peripheral members (e.g., a cooling member for a recording medium converging member and a fixing device) of the fixing device inside the main body of the image forming apparatus have to be changed into the status suited for the operation of the special-purpose fixing device. This is not described in Patent Literature 1 or 2. Actually the special-purpose fixing device is employed in the status wherein the general-purpose fixing device has been used. Alternatively, each user is often required to switch the status of the peripheral member manually.

However, if the special-purpose fixing device is mounted and the peripheral members of the fixing device are employed in the status wherein the general-purpose fixing device has been used, each of the peripheral members may not be suited to the special-purpose fixing device, with the result that the characteristics of the special-purpose fixing device cannot be completely utilized. Further, when the user manually switches the status of the peripheral member, the fixing device replacement efficiency will be reduced. If the manual status switching is omitted inadvertently, the characteristics of the special-purpose fixing device may not be fully employed.

### SUMMARY

In view of the problems described above, it is an object of the present invention to provide an image forming apparatus wherein the characteristics of a special-purpose fixing device can be fully utilized and the fixing device replacement efficiency is enhanced.

According to one aspect of the image forming apparatus, the apparatus comprises: an image formation section for forming a toner image based on image data on a recording medium; a first fixing device for fixing the toner image formed by the image formation section; an accommodation section for storing the first fixing device or a second fixing device having different specifications than those of the first fixing device; and a peripheral member arranged on a periphery of the accommodation section to operate synchronously with the first fixing device or second fixing device; wherein, when the first fixing device accommodated in the accommodation section has been replaced by the second fixing device, a status of the peripheral member is switched in conformity to specifications of the second fixing device.

According to further aspect of the image forming apparatus, the first fixing device and the second fixing device each have a fixing roller, and specifications of the first fixing device and the specifications of the second fixing device are determined by a profile, number and layout of the fixing rollers.

According to yet further aspect of the image forming apparatus, the peripheral member is any one of an air blow member for blowing air to the fixing roller, an upstream guide member arranged upstream of the first fixing device in a direction of conveying the recording medium for guiding the recording medium to the first fixing device from the image formation section; a downstream guide member arranged downstream of the first fixing device in the direction of conveying the recording medium for guiding the recording medium conveyed from the first fixing device; and a pressure member arranged downstream of the first fixing device in the direction of conveying, the recording medium for applying pressure to the recording medium fed from the first fixing device.

According to yet further aspect of the image forming apparatus, the peripheral member is the upstream guide member, and at least one of a position or profile of the upstream guide member is switched in conformity to the specifications of the second fixing device, when the first fixing device accommodated in the accommodation section has been replaced by the second fixing device.

According to yet further aspect of the image forming apparatus, the upstream guide member is a lower-side incoming guide for supporting the recording medium from a lower side of the recording medium, and, when the first fixing device accommodated in the accommodation section has been replaced by the second fixing device, a profile of the lower-side incoming guide is switched to either a profile protruding in a direction perpendicular to a printed surface of the recording medium or a flat profile at the central portion of the lower-side incoming guide in conformity to the specifications of the second fixing device.

According to yet further aspect of the image forming apparatus, the peripheral member is the air blow member, and, when the first fixing device accommodated in the accommodation section has been replaced by the second fixing device, either the position or profile of the air blow member is switched to blow air to the fixing roller of the second fixing device in conformity to the specifications of the second fixing device.

According to yet further aspect of the image forming apparatus, the peripheral member is the pressure member, and, when the first fixing device accommodated in the accommodation section has been replaced by the second fixing device, a nip pressure of the pressure member for applying pressure to the recording medium is switched in conformity to the specifications of the second fixing device.

According to yet further aspect of the image forming apparatus, the peripheral member is the downstream guide member, and the downstream guide member includes a first downstream guide member for guiding the recording medium conveyed from the first fixing device so as to hold the recording medium inside; and a second downstream guide member; wherein, when the first fixing device accommodated in the accommodation section has been replaced by the second fixing device, the distance between the first downstream guide member and the second downstream guide member is switched in conformity to the specifications of the second fixing device.

According to yet further aspect of the image forming apparatus, the image forming apparatus further comprises a control section to provide control in such a way that, when the first fixing device accommodated in the accommodation section has been replaced by the second fixing device, the operation status, of the image forming apparatus is controlled in conformity to the specifications of the second fixing device.

According to yet further aspect of the image forming apparatus, the image forming apparatus further comprises a blowing fan for blowing air to the fixing roller, and, when the first fixing device accommodated in the accommodation section has been replaced by the second fixing device, the control section provides control to switch the operation status of the blowing fan in conformity to the specifications of the second fixing device.

According to yet further aspect of the image forming apparatus, wherein when the first fixing device accommodated in the accommodation section has been replaced by the second fixing device, the control section controls an amount of heat energy to be applied to the fixing roller of the second fixing device in conformity to the specifications of the second fixing device.

According to yet further aspect of the image forming apparatus, wherein when the first fixing device accommodated in the accommodation section has been replaced by the second fixing device, the control section controls a frequency of replacing a cleaning web for cleaning the fixing roller of the second fixing device in conformity to the specifications of the second fixing device.

According to yet further aspect of the image forming apparatus, the image forming apparatus further comprises a selecting section for selecting at least one of a reversing mode for reversing and conveying a recording medium and a duplex printing mode for forming a toner image on both sides of the recording medium, wherein, when the first fixing device accommodated in the accommodation section has been replaced by the second fixing device, the control section controls the selecting section to disable selection of the reversing mode or duplex printing mode in conformity to the specifications of the second fixing device.

According to further aspect of the image forming apparatus, the image forming apparatus further comprises a detecting section for detecting that the first fixing device accommodated in the accommodation section has been replaced by the second fixing device.

### BRIEF DESCRIPTION OF THE DRAWINGS

FIG. 1 is block diagram representing an example of the structure of an image forming apparatus and image forming system;

FIGS. 2a-2d are schematic diagrams showing an example of the method for determining whether or not a fixing device has been replaced;

FIGS. 3a-3d are schematic diagrams showing the structure of the peripheral member;

FIG. 4 is a flow chart representing the operation of replacing the fixing device in an embodiment;

FIG. 5 is a flow chart representing the operation of replacing the fixing device being replaced, and accommodating the general-purpose fixing section into an accommodation section;

FIGS. 6a-6c are schematic diagrams representing the structure of the general-purpose fixing section and status of the peripheral member;

FIG. 7 is a flow chart representing the operation of replacing the fixing device and accommodating the fixing section for envelopes into the accommodation section;

FIGS. 8a-8c are schematic diagrams showing the structure of the fixing section for envelope and the status of the peripheral member;

FIG. 9 is a flow chart representing the operation of replacing the fixing device and accommodating the fixing section for postcards into the accommodation section;

FIGS. 10a-10c are schematic diagrams showing the structure of the fixing section for postcards and the status of the peripheral member;

FIG. 11 is a flow chart representing the operation of replacing the fixing device and accommodating the fixing section for 3d copying into the accommodation section;

FIGS. 12a-12c are schematic diagrams showing the structure of the fixing section for 3D copying and the status of the peripheral member;

FIGS. 13a-13c are schematic diagrams showing an example of the method for switching the lower-side incoming guide profile by the link mechanism; and

FIGS. 14a-14c are schematic diagrams showing another example of the method for switching the lower-side incoming guide profile by the link mechanism.

### DETAILED DESCRIPTION OF THE PREFERRED EMBODIMENT

The following describes the present invention with reference to the illustrated embodiments without the present invention being restricted thereto. The same or equivalent positions in the drawings will be assigned with the same reference numbers, and duplicated explanation may be omitted.

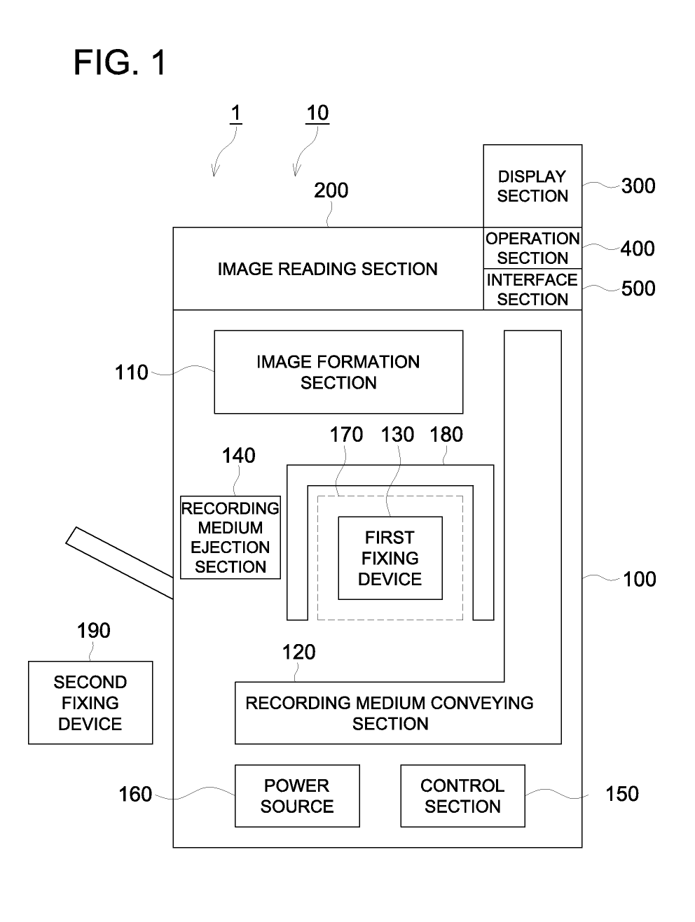

In the first place, referring to FIG. 1, the following describes the example of the structure of the image forming apparatus and image forming system in an embodiment of the present invention. FIG. 1 is block diagram representing an example of the structure of an image forming apparatus and image forming system.

In FIG. 1, the image forming apparatus 10 includes an enclosure 100, image reading section 200, display section 300, operation section 400 and interface section (hereinafter referred to as “I/F section”) 500. The enclosure 100 is equipped with various components for forming an image on a recording medium S. The image reading section 200 is a so-called scanner, which generates image data by optically reading the image and applying photoelectric conversion to the image having been read.

The display section 300 includes a liquid crystal panel, for example, and displays the details of the operation performed by the operation section 400, and the operation status of the image forming apparatus 10. The operation section 400 includes a keyboard and switches arranged on the periphery of the display section 300 and a touch panel arranged on the display section 300, for example. The operation section 400 is employed by the user to set or enter the information on the operation mode of the image forming apparatus 10 or the number of sheets for image formation. The I/F section 500 is used to exchange information on image data and others with external equipment linked to the image forming apparatus 10.

The enclosure 100 incorporates an image formation section 110, recording medium conveying section 120, the first fixing device 130, recording medium ejection section 140, the control section 150, power source 160 and others. The first fixing device 130 is accommodated removably in the accommodation section 170 inside the enclosure 100 so that the first fixing device 130 can be mounted or removed when pulled out or pushed in, for example, in the direction perpendicular to the sheet surface in the drawing. A peripheral member 180 relates to fixing is mounted on the periphery of the accommodation section 170.

The image formation section 110 forms a toner image on the recording medium S based on the image data read by the image reading section 200 or the image data inputted from the external equipment through the I/F section 500. The recording medium conveying section 120 conveys the recording medium S. The first fixing device 130 fixed the toner image formed by the image formation section 110. The recording medium ejection section 140 ejects out of the enclosure 100 the recording medium S with the toner image fixed thereon by the first fixing device 130. The control section 150 controls the operation of the image forming apparatus 10. The power source 160 supplies power to each component of the image forming apparatus 10.

The image forming system 1 includes the aforementioned image forming apparatus 10 and a second fixing device 190 having different specifications from those of the first fixing device 130. The second fixing device 190 is interchangeable with the first fixing device 130. Replaced by the first fixing device 130, the second fixing device 190 can be removably accommodated in the accommodation section 170 inside the enclosure 100 of the image forming apparatus 10. The type of the second fixing device 190 is not restricted to one. A plurality affixing devices having different specifications from those of the first fixing device 130 can be mounted.

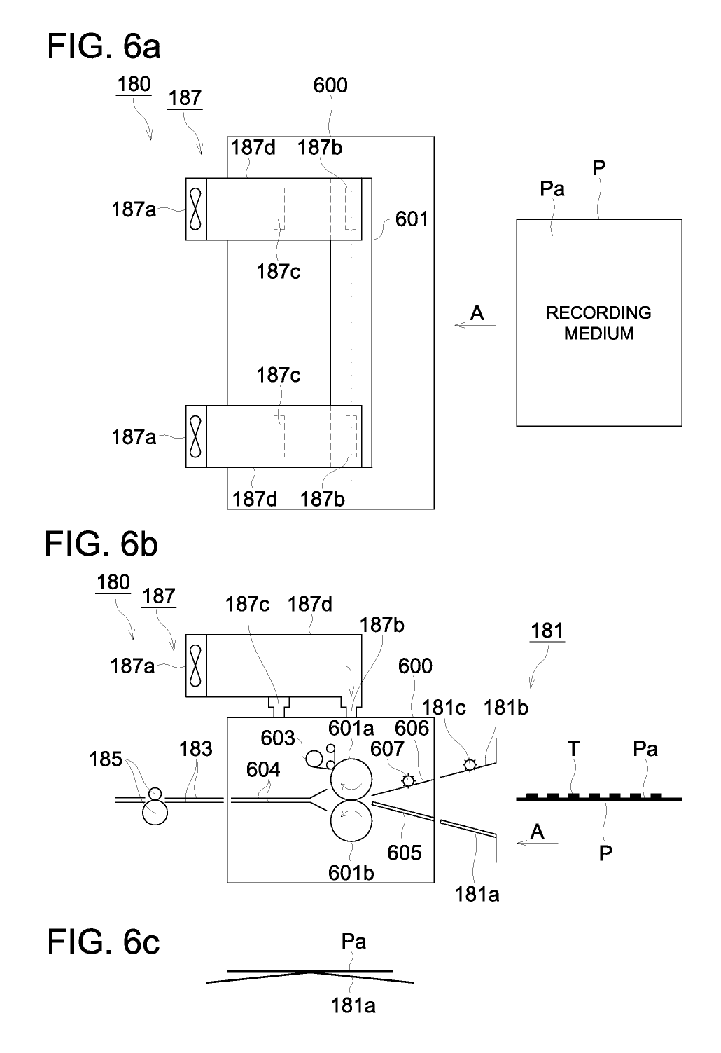

The specifications of the first fixing device 130 and the second fixing device 190 are determined by the profile, number and layout of the fixing rollers to be described later. Details of the specifications will be described with reference to FIG. 6 and later drawings.

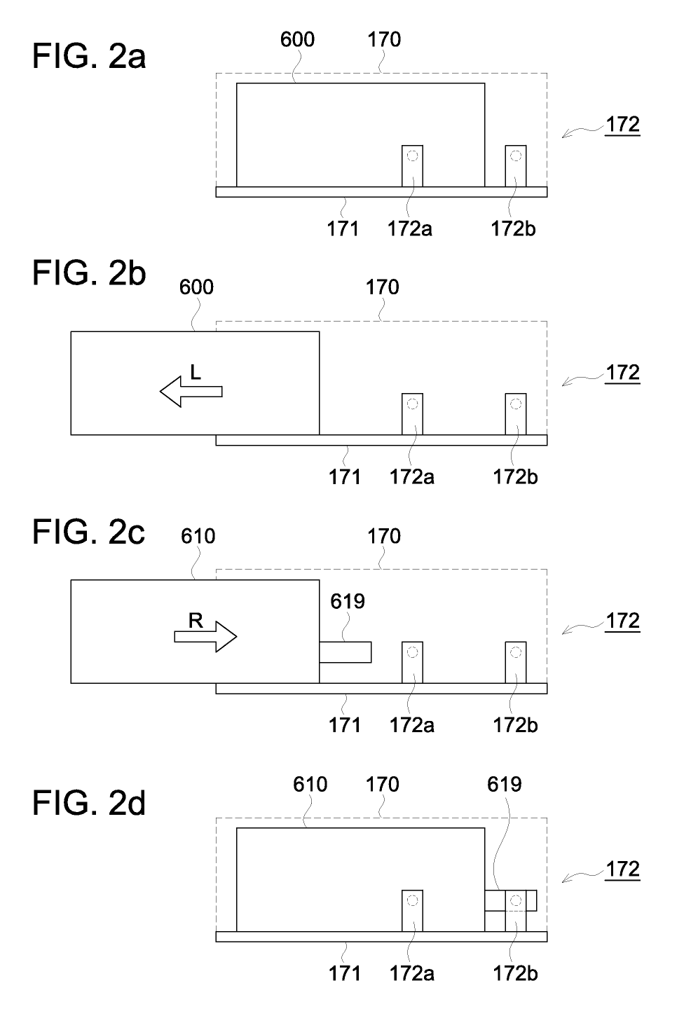

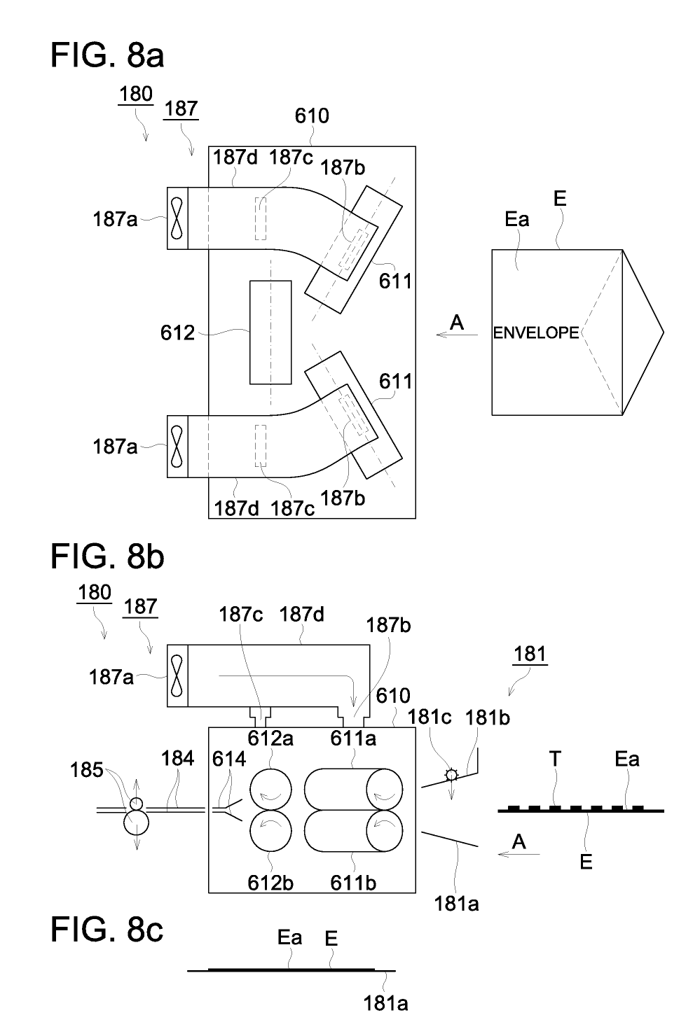

Referring to FIGS. 2a-2d, the following describes the method for determining whether or not a fixing device has been replaced in the image forming apparatus of the embodiment in the present invention. FIGS. 2a-2d are schematic diagrams showing an example of the method for determining whether or not a fixing device has been replaced. FIG. 2a and FIG. 2B show that the first fixing device is removed. FIG. 2c and FIG. 2d show that the second fixing device is mounted. In the following description, the general-purpose fixing section to be described later with reference to FIGS. 6a-6c is used as an example of the first fixing device. The fixing section for envelopes described with reference to FIG. 8 is used as an example of the second fixing device.

In FIG. 2a, the general-purpose fixing section 600 is supported by the guide rail 171 of the accommodation section 170, and is accommodated removably in the accommodation section 170. The accommodation section 170 is provided with a replacement sensor 172a made up of a photo-reflector, for example, and a type sensor 172b, as detectors 172 for determining whether or not the fixing device has been replaced.

When the general-purpose fixing section 600 or fixing section for envelopes 610 is mounted at a regular position, the replacement sensor 172a is mounted where the general-purpose fixing section 600 or fixing section for envelopes 610 can be detected. As will be described later, when the fixing section for envelopes 610 is accommodated at the regular position, the type sensor 172b is mounted where the type determining plate 619 of the fixing section for envelopes 610 can be detected.

To be more specific, in the state shown in FIG. 2a, the detector 172 detects through the replacement sensor 172a that any one of the general-purpose fixing section 600 and fixing section for envelopes 610 is accommodated at a regular position. Further, the detector 172 detects through the type sensor 172b that the general-purpose fixing section 600 is accommodated.

In FIG. 2B, if the general-purpose fixing section 600 is pulled out along the guide rail 171 in the direction of arrow mark L, the replacement sensor 172a cannot detect the general-purpose fixing section 600 any more. This indicates that the general-purpose fixing section 600 has been removed.

In FIG. 2c, when the fixing section for envelopes 610 is accommodated at the regular position, a type determining plate 619 is installed where the optical path of the type sensor 172b is blocked.

Thus, when the fixing section for envelopes 610 is mounted along the guide rail 171 in the direction of arrow mark R and is accommodated at the regular position shown in FIG. 2d, the detector 172 detects through the replacement sensor 172a that any one of the general-purpose fixing section 600 and fixing section for envelopes 610 is accommodated at the regular position. Further, the detector 172 detects through the type sensor 172b that the fixing section for envelopes 610 is accommodated. To be more specific, the detector 172 determines that the fixing device has been replaced.

Conversely, when the fixing section for envelopes 610 accommodated in the accommodation section 170 has been replaced by the general-purpose fixing section 600, the status of FIG. 2d is changed into the status of FIG. 2a. This allows the detector 172 to detect the replacement.

If the general-purpose fixing section 600 removed in FIG. 2B has been mounted again, the status of FIG. 2a is regained when the general-purpose fixing section 600 has been accommodated at the regular position. Thus, the detector 172 knows that the removed general-purpose fixing section 600 has been mounted again, and the original status has been regained. Similarly, the detector 172 knows that the fixing section for envelopes 610 is removed and mounted again, whenever such a procedure has been performed.

When three or more types of fixing devices are to be identified, a plurality of lengths and heights of the type determining plates 619, for example, are preset and a plurality of type sensors 172h are installed. This is one of the possible ways of identifying many types of the fixing devices.

FIG. 2 also shows an example wherein the replacement sensor 172a and type sensor 172b are installed as detectors 172, without the present invention being restricted thereto. For example, it is also possible to design the following structure. Each of the general-purpose fixing section 600 and fixing section for envelopes 610 is provided with a barcode or two-dimensional code indicating the type and specifications. The barcode or two-dimensional code is attached at the point opposed to the replacement sensor 172a in the regular accommodation position. When the code is read by the code reader mounted at the position of the replacement sensor 172a of the accommodation section 170, replacement of the fixing device can be determined.

It is also possible to arrange such a configuration that each of the general-purpose fixing section 600 and fixing section for envelopes 610 is provided with an IC tag showing the type and specifications. The tag is read by the reading device mounted on the accommodation section 170, and the replacement of the fixing device is determined.

The method of identification using a barcode, two-dimensional code and IC tag is effective in identifying three or more types of fixing devices, in particular.

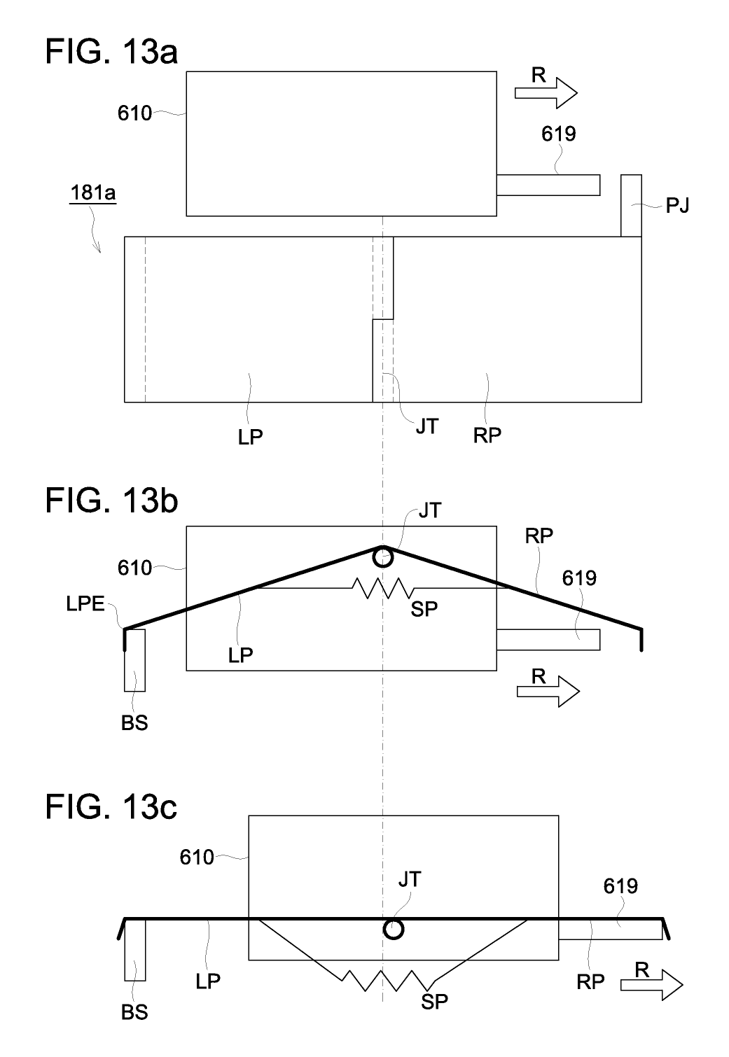

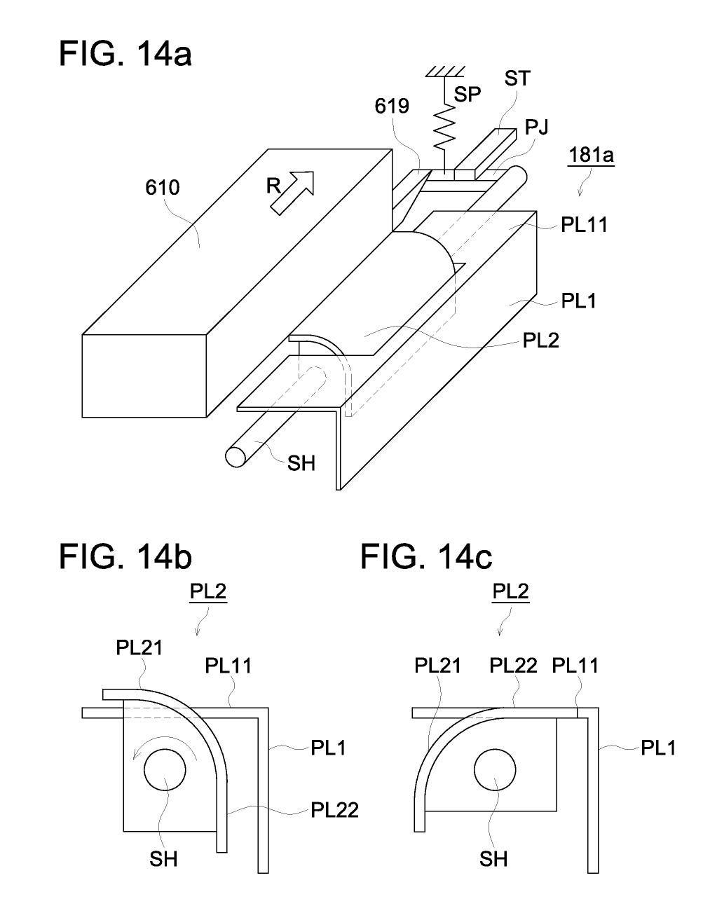

A mechanical operation such as the operation of a link mechanism can be used to perform the operation requited to replace the fixing device, without using the aforementioned electric detection means. Referring to FIGS. 13 and 14, the details will be described with reference to an example.

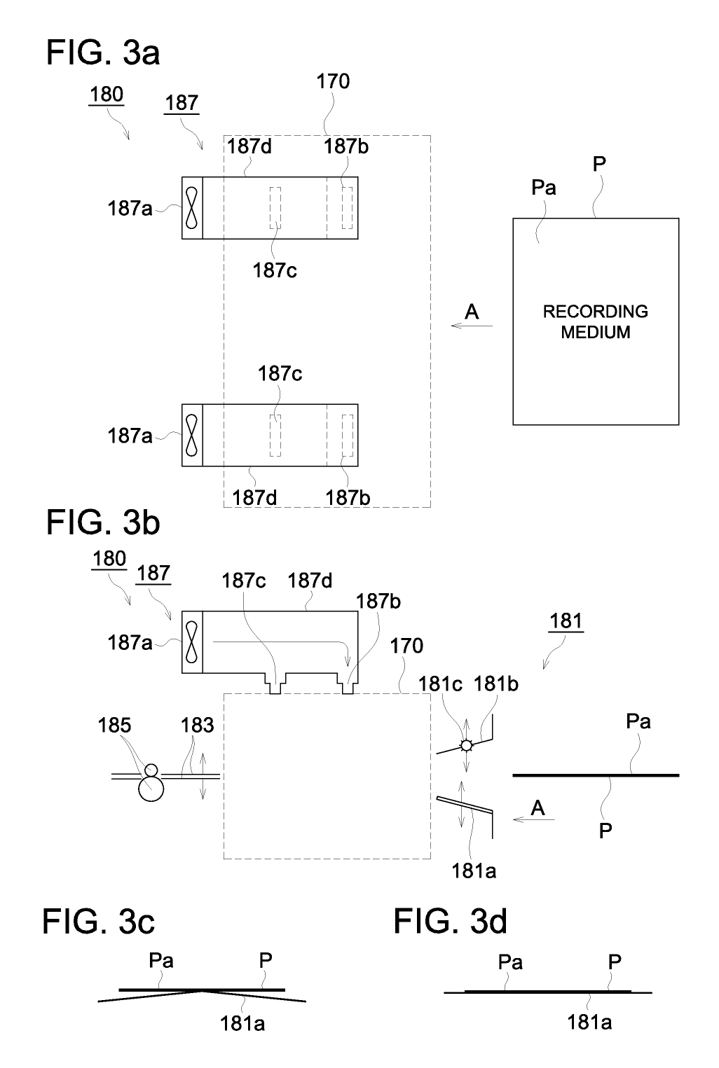

The structure of the peripheral member arranged on the periphery of the accommodation section of FIG. 1 will be explained with reference to FIGS. 3a-3d. FIGS. 3a-3d are schematic diagrams representing the structure of the peripheral member. FIG. 3a shows the upper surface as viewed from the side of the printed surface of the recording medium. FIG. 3B is the side view as observed from the lateral surface of the recording medium. FIG. 3c and FIG. 3d are schematic diagrams showing the profile of the lower-side incoming guide as part of the peripheral member.

In FIG. 3a, the upper portion of the accommodation section 170 is equipped with a pair of air blow members 187 for cooling part or the whole of the fixing roller of the fixing device accommodated in the accommodation section 170. A pair of air blow members 187 each includes an air blow fan 187a, the first air blow port 187b, second air outlet 187c and ventilation duct 187d.

The ventilation duct 187d is made up of bellows, for example. The ventilation duct 187d can be rotated and bent by a drive mechanism such as a link mechanism or motor (not illustrated), in such a way that at least the position of the first air outlet 187b is switched between the reference position and a plurality of prescribed positions. The second air outlet 187c can be opened or closed, for example, by the shutter mechanism (not illustrated) provided on the ventilation duct 187d. Further, the ventilation fan 187a can be switched between the ventilation mode and non-ventilation mode by the control section 150.

In FIG. 3B, the peripheral member 180 includes an upstream guide member 181, downstream guide member 183 and pressure member 185, in addition to the aforementioned air blow member 187.

To guide the recording medium P fed from the image formation section 110 of FIG. 1 toward the fixing device accommodated in the accommodation section 170, the upstream guide member 181 is arranged upstream of the accommodation section 170 in the direction of the recording medium P being conveyed (arrow mark A). The upstream guide member 181 includes a lower-side incoming guide 181a, upper-side incoming guide 181b and ratchet wheel guide 181c.

The recording medium P fed from the image formation section 110 to the fixing device accommodated in the accommodation section 170 is supported from the lower side by a guide plate which constitutes the lower-side incoming guide 181a. The profile can be switched at least between the profile wherein the central portion protrudes in the direction perpendicular to the printed surface Pa of the recording medium P, as shown in FIG. 3c, and the flat profile shown in FIG. 3d. Switching between these two profiles can be achieved by a drive mechanism such as a link mechanism or motor (not illustrated).

Further, the lower-side incoming guide 181a can be set by a drive mechanism such as a link mechanism or motor (not illustrated) to one of the following three positions; the reference position, a position closer to the sheet conveyance path of the recording medium P than the reference position, and a position far from the sheet conveyance path of the recording medium P.

By regulating the position and profile of the recording medium P from the upper side, the upper-side incoming guide 181b and ratchet wheel guide 181c allow a curled recording medium P to enter the fixing device accommodated in the accommodation section 170.

The ratchet wheel guide 181c can be switched by a drive mechanism such as a link mechanism or motor (not illustrated) to any one of the following three positions; the reference position, a position closer to the sheet conveyance path of the recording medium P than the reference position, and a position far from the sheet conveyance path of the recording medium P.

The downstream guide member 183 is intended to guide the recording medium P ejected from the fixing device accommodated in the accommodation section 170 to reach the pressure member 185. This downstream guide member 183 is a pair of guide plates having a prescribed space arranged downstream of the accommodation section 170 in the traveling direction of the recording medium P. The prescribed space of the downstream guide member 183 can be switched by a drive mechanism such as a link mechanism or motor (not illustrated) between at least the following two spaces; the reference space and a space wider than the reference space.

The pressure member 185 is a pair of rollers for applying a prescribed nip pressure for the purpose of correcting the curl of the recording medium P ejected from the fixing device accommodated in the accommodation section 170, and is arranged downstream of the accommodation section 170 in the traveling direction of the recording medium P. This pressure member 185 is commonly called the decurler. The nip pressure of the pressure member 185 can be switched by a drive mechanism such as a link mechanism or motor (not illustrated) among at least four pressures; reference nip pressure, high nip pressure higher than the reference nip pressure, low nip pressure lower than the reference nip pressure, and nip release pressure.

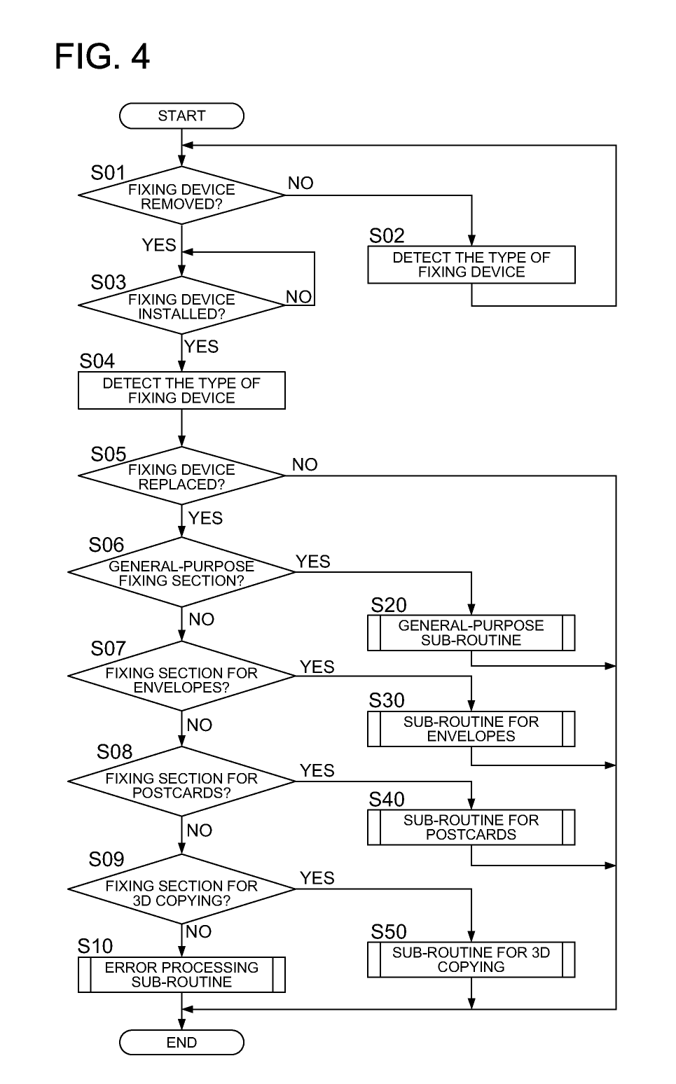

The following describes the embodiment of the present invention with reference to drawings from FIG. 4 to FIGS. 12a-12c.

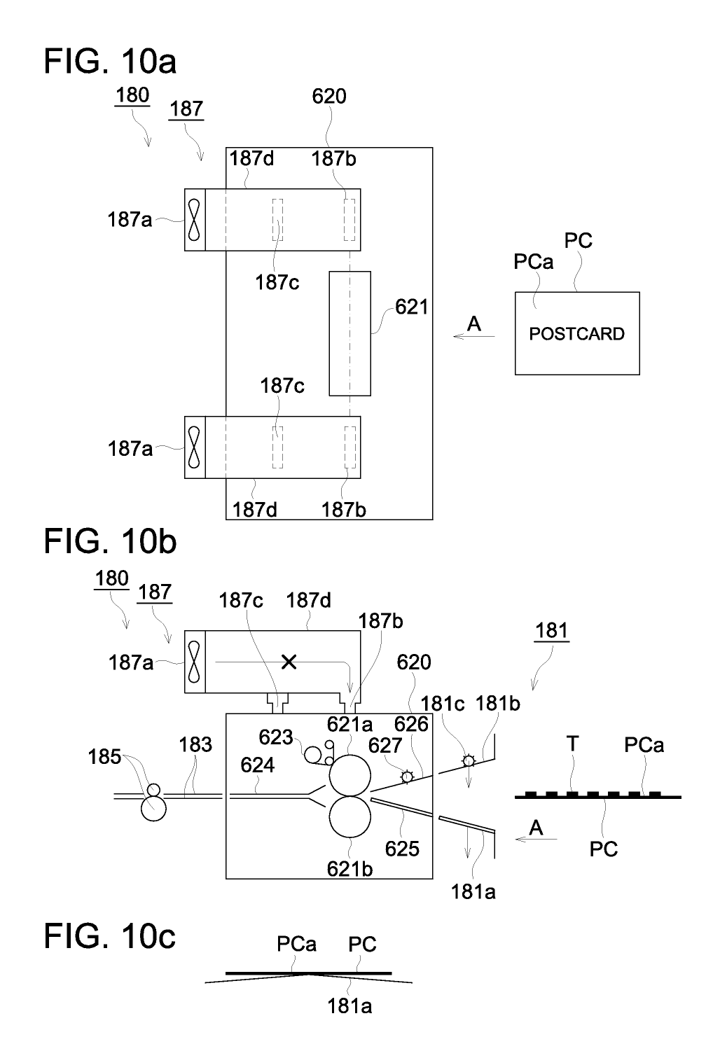

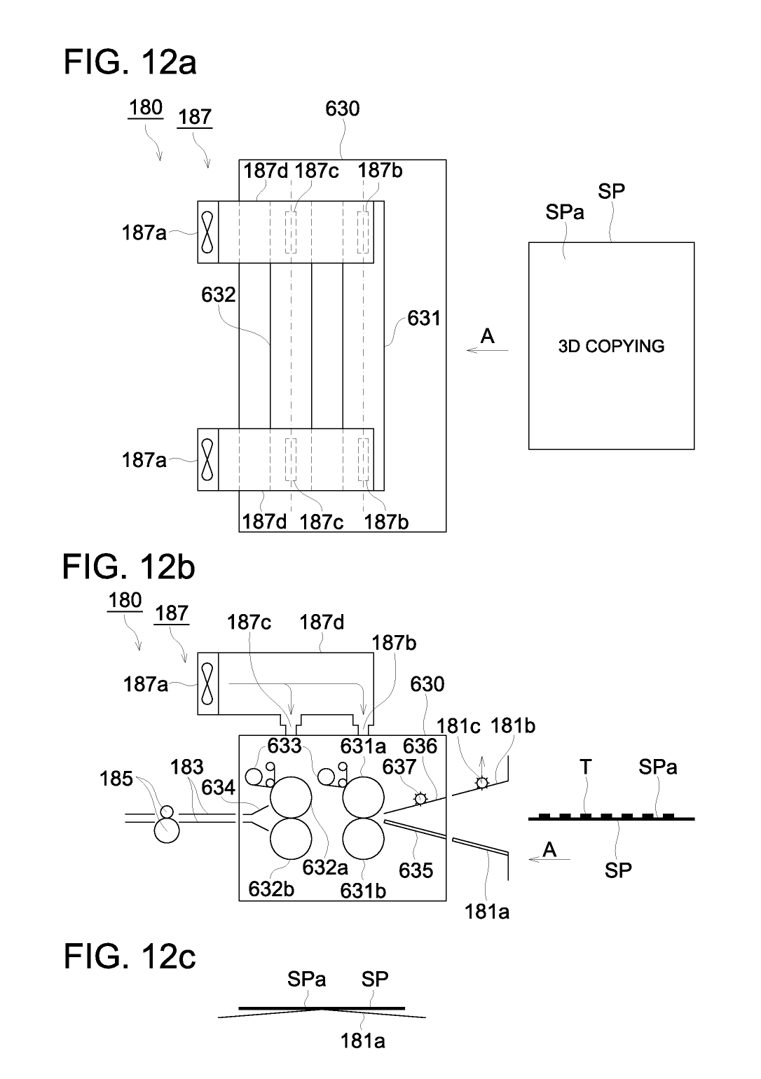

FIG. 4 is a flow chart representing the operation of replacing the fixing device in an embodiment. The following describes the image forming system wherein four types of fixing devices can be replaced. The four types of fixing devices include a general-purpose fixing section 600 (FIG. 6) used for general-purpose requirements, a fixing section for envelopes 610 (FIG. 8) for fixing a toner image formed on an envelope as a special-purpose fixing device, a fixing section for postcards 620 (FIG. 10) for fixing a toner image formed on a postcard, and a fixing section for 3D copying 630 (FIG. 12) for fixing a toner image formed on 3D copying paper.

In FIG. 4, the replacement sensor 172a of FIG. 2, for example, verifies in Step S01 whether or not the fixing device accommodated in the accommodation section 170 of the image forming apparatus 10 has been removed.

If the fixing device has not yet been removed (Step S01: No), the type of the fixing device accommodated in the accommodation section 170 (i.e., which of the aforementioned four types is accommodated) is detected and memorized in Step S02, for example, by the type sensor 172b of FIG. 2. Steps S01 and S02 are repeated until the fixing device is removed.

If the fixing device has been removed (Step S01: Yes), whether the fixing device has been removed or not is checked in Step S03, for example, by the replacement sensor 172a of FIG. 2. Step S03 is repeated until the fixing device is removed.

If the fixing device has been mounted (Step S03: Yes), the type of the mounted fixing device mounted (i.e., which of the aforementioned four types is mounted) is checked in Step S04 by the type sensor 172b.

In Step S05, the type of the mounted fixing device detected in Step S02 is compared with the type of the mounted fixing device detected in Step S04, thereby checking whether or not the fixing device has been replaced by a different fixing device.

If the fixing device has not been replaced by a different fixing device (Step S05: No), the removed fixing device has only been put back to the original position. Thus, the operation terminates. If the fixing device has been replaced by a different fixing device (Step S05: Yes), whether or not the replaced fixing device is a general-purpose fixing section 600 is checked in Step S06. If the replaced fixing device is a general-purpose fixing section 600 (Step S06: Yes), “General-purpose sub-routine” in Step S20 is executed and a series of operations terminates.

If the replaced fixing device is not a general-purpose fixing section 600 (Step S06: No), whether or not the replaced fixing device is a fixing section for envelopes 610 is checked in Step S07. If the replaced fixing device is a fixing section for envelopes 610 (Step S07: Yes), “Sub-routine for envelopes” of Step S30 is executed and a series of operations terminates.

If the replaced fixing device is not a fixing section for envelopes 610 (Step S07: No), whether or not the replaced fixing device of a fixing section for postcards 620 is checked in Step S08. If the replaced fixing device is a fixing section for postcards 620 (Step S08: Yes), “Sub-routine for postcards” of Step S40 is executed and a series of operations terminates.

If the replaced fixing device is not a fixing section for postcards 620 (Step S08: No), whether or not the replaced fixing device is a fixing section for 3D copying 630 is checked in Step S09. If the replaced fixing device is a fixing section for 3D copying 630 (Step S09: Yes), “Sub-routine for 3D copying” of Step S50 is executed and a series of operations terminates.

If the replaced fixing device is not a fixing section for 3D copying 630 (Step S09: No), the fixing device has been replaced by none of the aforementioned four types of fixing devices. Thus, the system proceeds to “Error processing sub-routine” of Step S10. Then an error alarm is displayed on the display section 300 or error processing is performed via the network in such a way that a request is made to maintain the image forming apparatus 10, for example. Then a series of operations terminates.

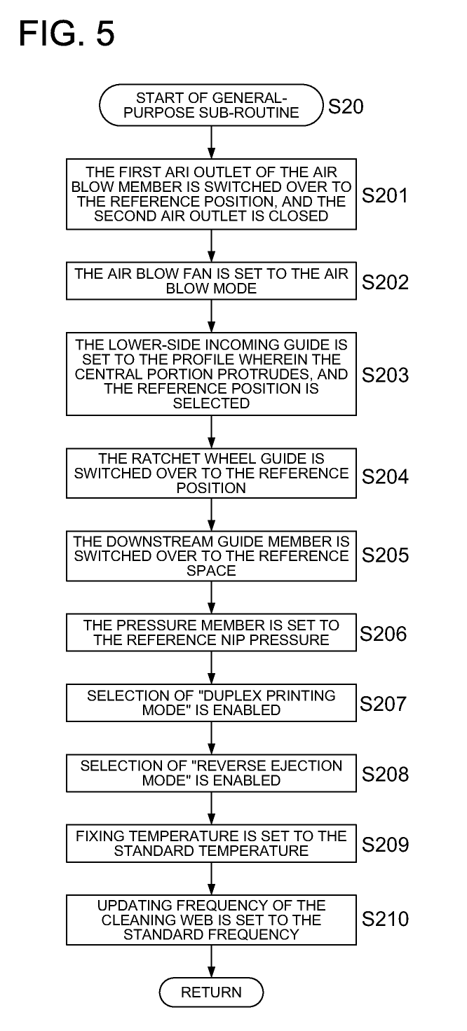

The following describes the “General-purpose sub-routine” of Step S20 with reference to FIG. 5 and FIG. 6. FIG. 5 is a flow chart showing the operation wherein the fixing device is replaced and a general-purpose fixing section is accommodated in the accommodation section. FIG. 6 is a schematic diagram representing the structure of the general-purpose fixing section, and the status of the peripheral member. FIG. 6a shows the super surface of a recording medium as viewed from the printed surface. FIG. 6B is a side view of the recording medium as viewed from the side. FIG. 6c is a schematic diagram representing the profile of the lower-side incoming guide constituting a peripheral member.

In the first place, the structure of the general-purpose fixing section 600 will be described with reference to FIGS. 6a-6c.

In FIGS. 6a-6c, the general-purpose fixing section 600 is a fixing device used for fixing an image on the general-purpose recording medium P such as a copying sheet, and includes a pair of fixing rollers 601 (601a and 601b), cleaning web 603, ejection guide 604, lower-side introducing plate 605, upper side-introducing plate 606 and introducing ratchet wheel 607. The specifications of the general-purpose fixing section 600 are determined by the profile, number and layout of a pair of fixing rollers 601.

At least one (601a) of a pair of fixing rollers 601 incorporates a heater. The recording medium P is sandwiched by the nip between the roller 601a and roller 601b. While rotating in the direction of the arrow mark in the drawing, the roller applies heat and pressure to the recording medium P, thereby fixing the toner imager on the printed surface Pa of the recording medium P. The roller has a length greater than the maximum length of the recording medium P on which an image is fixed, and is arranged perpendicular to the traveling direction of the recording medium P (arrow mark A).

The cleaning web 603 is a cleaning device wherein paper or cloth wound in a roll is pressed against the fixing roller 601, and is taken up at a prescribed speed. Then the residual toner and other contamination are removed from the fixing roller 601 by the cleaning web 603. The cleaning web 603 is provided in contact with the fixing roller 601a located on the side of the printed surface Pa of the recording medium P.

The ejection guide 604 is a guide plate for ensuring that the recording medium P on which an image is fixed by the fixing roller 601 is ejected from the general-purpose fixing section 600 to the outside.

The lower-side introducing plate 605, upper side-introducing plate 606 and introducing ratchet wheel 607 are the guiding devices that introduce the recording medium P into the nip portion of the fixing roller 601. The lower-side introducing plate 605 supports the recording medium P from the lower side. Similarly to the case of the lower-side incoming guide 181a to be described later with reference to FIG. 6c, the central portion protrudes in the traveling direction of the recording medium P (arrow mark A) and in the direction perpendicular to the printed surface Pa of the recording medium P.

By regulating the position and profile of the recording medium P from the upper side, the upper side-introducing plate 606 and introducing ratchet wheel 607 ensure that the recording medium P is introduced into the nip portion of the fixing roller 601, despite the presence of a curl and other defects on the recording medium P.

In FIG. 5, a step is taken to determine that the fixing device having been replaced and accommodated into the accommodation section 170 in Step S06 of FIG. 4 is a general-purpose fixing section 600 (Step S06: Yes). In “General-purpose sub-routine” of Step S20, the peripheral member 180, general-purpose fixing section 600 and image forming apparatus 10 are switched over to the statuses suited for the general-purpose fixing section 600.

Steps S201 through S206 are the procedures for converting the statuses of the peripheral member 180 into those suited for the general-purpose fixing section 600.

In the first place, in Step S201, the first air outlet 187b of the air blow member 187 is switched over to the reference position described with reference to FIG. 3a, as shown in FIG. 6a. At the same time, the second air outlet 187c is closed by the shutter (not illustrated) provided on the ventilation duct 187d. In this case, the reference position is where the first air outlet 187b opens above both ends of the fixing roller 601.

This is followed by the Step S202 wherein the ventilation fan 187a of the air blow member 187 is switched to the ventilation mode, and ventilation starts.

This will reduce the chances of being used for fixing, except when an image is fixed onto a large-format recording medium P. Therefore, it is possible to only cool both ends of the fixing roller 601 which are more likely to be overheated than the central portion thereof.

In Step S203, the lower-side incoming guide 181a described with reference to FIG. 3c is set to the profile wherein the central portion protrudes in the traveling direction of the recording medium P (arrow mark A) of FIG. 6c and in the direction perpendicular to the printed surface Pa of the recording medium P. At the same time, the position of the power-side incoming guide 181a is switched over to the reference position described with reference to FIG. 3B.

In Step S204, the ratchet wheel guide 181c is switched over to the reference position described with reference to FIG. 3B.

In Step S205, the downstream guide member 183 is switched over to the reference space described with reference to FIG. 3B.

In Step S206, the pressure member 185 is set to the reference nip pressure (e.g., 50 N) described with reference to FIG. 3.

Steps from S207 through S210 are intended to ensure that the interior of the general-purpose fixing section 600 and image forming apparatus 10 are switched over to the statuses suited for the general-purpose fixing section 600.

In Step S207, control is switched over to enable the control section 150 to select the “Duplex printing mode” out of the operation modes of the image forming apparatus 10. This allows selection of the “Duplex printing mode” using the operation section 400.

In Step S208, control is switched to enable the control section 150 to select the “Reverse ejection mode” out of the operation modes of the image forming apparatus 10. This allows selection of the “Reverse ejection mode” using the operation section 400.

In Step S209, the fixing temperature of the fixing roller 601 is set to the standard temperature (e.g., 200 degrees Celsius) by the control section 150 so that the temperature is controlled.

In Step S210, the updating frequency of the cleaning web 603 is set to the standard frequency. To put it another way, the roll take-up speed of the cleaning web 603 is set to the standard speed. The control returns to the “General-purpose sub-routine” of Step S20 of FIG. 4. The peripheral member 180, the interior of the general-purpose fixing section 600 and image forming apparatus 10 are switched over to the statuses suited for the general-purpose fixing section 600 by the aforementioned Steps.

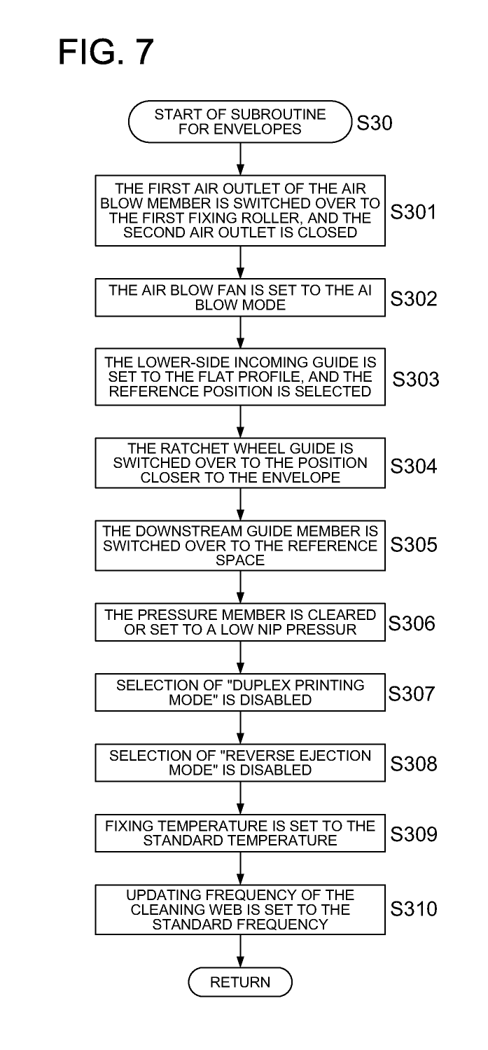

Referring to FIGS. 7 and 8, the following describes the “Sub-routine for envelopes” of Step S30. FIG. 7 is a flow chart representing the operation of replacing the fixing device and accommodating the fixing section for envelopes into the accommodation section. FIGS. 8a-8c are schematic diagrams showing the structure of the fixing section for envelopes and the status of the peripheral member. FIG. 8a shows the upper surface as viewed from the printed surface of the envelope as a recording medium. FIG. 8B is a side view of an envelope as viewed from the side, and FIG. 8c is a schematic diagram showing the profile of the lower-side incoming guide.

In the first place, the following describes the structure of the fixing section for envelopes 610 with reference to FIGS. 8a-8c.

In FIGS. 8a-8c, the fixing section for envelopes 610 is a special-purpose fixing device used to fix the toner image T formed on the printed surface Ea of the envelope E as a recording medium P, and includes two pairs of first fixing rollers 611, a pair of second fixing rollers 612, ejection guide 614 and cleaning web 613 (not illustrated). In addition, the fixing section 610 can include a lower-side introducing plate 615, upper side-introducing plate 616 and introducing ratchet wheel 617 (not illustrated) having the same function as those of the general-purpose fixing section 600. The specifications of the fixing section for envelopes 610 are determined by the profile, number and layout of the two pairs of first fixing rollers 611 and a pair of second fixing rollers 612.

The two pairs of first fixing rollers 611 (each consisting of 611a and 611b) each are shorter than the fixing roller 601 of the general-purpose fixing section 600, and are placed in an inverted-V shape, in so-called staggered arrangement, inclined in the traveling direction of the envelope E (arrow mark A). Two pairs of first fixing rollers 611 each are provided with a built-in heater in at least one of the rollers (611a). An envelope E is sandwiched by the nip between the roller 611a and roller 611b. Rotating in the arrow marked direction of the drawing, these rollers apply heat and pressure to the envelope E, so that the toner image T is fixed on the printed surface Ea of the envelope E.

Similarly, a pair of the second fixing rollers 612 (612a and 612b) is shorter than the fixing roller 601 of the general-purpose fixing section 600, and is arranged at the center of the traveling direction of the envelope E (arrow mark A) in the direction perpendicular to the traveling direction (arrow mark A). At least one (612a) of the second fixing rollers 612 incorporates a heater. The envelope E is sandwiched by the nip between the roller 612a and roller 612b. While rotating in the arrow marked direction of the drawing, these rollers apply heat and pressure to the envelope E, so that the toner image T is fixed on the printed surface Ea of the envelope E.

Two pairs of first fixing rollers 611 and a pair of second fixing rollers 612 are so arranged that each fixing range is overlapped with the other, when viewed from the traveling direction of the envelope E (arrow mark A), as shown in FIG. 8a. This layout prevents wrinkles from being formed on the envelope E by the air remaining inside the envelope E at the time of fixing. The nip pressure of each fixing roller with respect to the fixing section for envelopes 610 is 167 N, for example.

Each of the two rollers, first fixing roller 611a and the second fixing roller 612a, is provided with a cleaning web 613 (not illustrated for easy viewing). The cleaning web 613 is the same as the cleaning web 603 described with respect to FIGS. 6a-6e.

The ejection guide 614 is a guide plate for ensuring that the envelope E on which an image has been fixed by the first fixing roller 611 and the second fixing roller 612 is ejected to the outside from the fixing section for envelopes 610. The ejection guide 614 is made up of two plates arranged at a prescribed space.

In FIG. 7, when the fixing device replaced and accommodated in the accommodation section 170 in Step S07 of FIG. 4 has been identified as a fixing section for envelopes 610 (Step S07: Yes), the statuses of the peripheral member 180, the interior of the fixing section for envelopes 610 and image forming apparatus 10 are changed in the “Sub-routine for envelopes” of Step S30.

Steps from S301 through Step S306 are intended to switch the status of the peripheral member 180 to that suited for the fixing section for envelopes 610.

In the first place, in Step S301, the first air outlet 187b of the air blow member 187 is switched over to the position wherein the first air outlet 187b opens above each of the two pairs of first fixing rollers 611 shown in FIG. 8a. At the same time, the second air outlet 187c is closed by a shutter (not illustrated) arranged on the ventilation duct 187d, for example.

This is followed by the Step S302 wherein the ventilation fan 187a of the air blow member 187 is set to the ventilation mode by the control section 150 so that ventilation starts.

The aforementioned procedure will reduce the chances of being used for fixing, except when an image is fixed onto a large-format envelope E. Therefore, it is possible to only cool both ends of the fixing roller 611 which are more likely to be overheated than the second fixing roller 612.

In Step S303, the lower-side incoming guide 181a is switched over to the flat profile shown in FIG. 8c. Thus, the envelope E more rigid than the general-purpose recording medium P is prevented from floating when the envelope E is conveyed on the lower-side incoming guide 181a. Similarly to the case of the general-purpose fixing section 600, the lower-side incoming guide 181a is positioned at the reference position described with reference to FIG. 3B.

In Step S304, the ratchet wheel guide 181c is switched over to the position closer to the sheet conveyance path of the envelope E than the reference position described with reference to FIG. 3B. This prevents the so-called bottom rubbing wherein the envelope E abuts on the upper-side incoming guide 181b, when the envelope E is conveyed.

In Step S305, the downstream guide member 183 is set to the reference space described with reference to FIG. 3B.

In Step S306, the pressure member 185 is cleared or set to the low nip pressure (e.g., 25 N). This is because the amount of curl of the envelope E is smaller than that of the general-purpose recording medium P.

Steps from S307 through S310 are intended to ensure that the interior of the fixing section for envelopes 610 and image forming apparatus 10 are switched over to the statuses suited to the fixing section for envelopes 610.

In Step S307, control is switched by the control section 150 to disable selection of the “Duplex printing mode” out of the operation modes of the image forming apparatus 10. Thus, the selection of the “Duplex printing mode” using the operation section 400 is disabled. At the same time, the control section 150 allows the display section 300 to indicate that selection of the “Duplex printing mode” has been disabled, for example.

In Step S308, control is switched by the control section 150 to disable selection of “Reverse ejection mode” out of the operation modes of the image forming apparatus 10. Thus, the selection of the “Reverse ejection mode” using the operation section 400 is disabled. At the same time, the control section 150 allows the display section 300 to indicate that selection of the “Reverse ejection mode” has been disabled, for example. In the embodiment of the present invention, the operation section 400 corresponds to the selecting section.

The aforementioned two Steps protect against a possible paper jam or other trouble that may be caused by applying duplex printing or reverse ejection to the envelope E with a flap more rigid than the general-purpose recording medium P.

In Step S309, the control section 150 allows the fixing temperature of the fixing roller 601 to be set to the standard temperature (e.g., 200 degrees Celsius) so that the temperature is placed under control.

In Step S310, the updating frequency of the cleaning web 613 is set to the standard frequency. To put it another way, the take-up speed of the cleaning web 613 is set to the standard speed, and the control goes back to the “Sub-routine for envelopes” of Step S30 in FIG. 4. The aforementioned steps ensure that the peripheral member 180, the interior of the fixing section for envelopes 610 and image forming apparatus 10 are switched over to the statuses suited for the fixing section for envelopes 610.

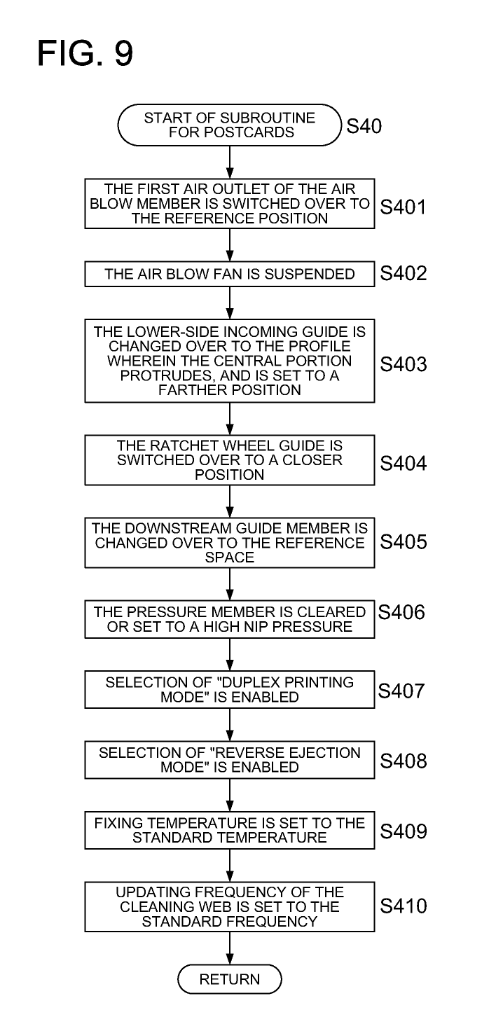

The following describes the “Sub-routine for postcards” of Step S40 with reference to FIG. 9 and FIGS. 10a-10e. FIG. 9 is a flow chart representing the operation of replacing the fixing device and accommodating the fixing section for postcards into the accommodation section. FIGS. 10a-10c are schematic diagrams showing the structure of the fixing section for postcards and the status of the peripheral member. FIG. 10a is a top view of the postcard as a recording medium as viewed from the printed surface. FIG. 10B is a side view of the postcard as viewed from the side. FIG. 10c is a schematic diagram representing the profile of the lower-side incoming guide.

In the first place, the following describes the structure of the fixing section for postcards 620 with reference to FIG. 10.

In FIG. 10, the fixing section for postcards 620 is a special-purpose fixing device used to fix the toner image T formed on the printed surface PCa of the postcard PC as a recording medium P. The fixing section for postcards 620 includes a pair of fixing rollers 621, cleaning web 623, ejection guide 624, lower-side introducing plate 625, upper side-introducing plate 626 and introducing ratchet wheel 627. The specifications of the fixing section for postcards 620 are determined by the profile, number and layout of a pair of fixing rollers 621.

A pair of fixing rollers 621 (621a and 621b) is shorter than the fixing roller 601 of the general-purpose fixing section 600, to meet the requirements in the width of the postcard PC. These fixing rollers 621 are located at the center in the traveling direction (arrow mark A) of the postcard PC perpendicular to the traveling direction (arrow mark A). The nip pressure between the fixing roller 621a and 621b is set at a nip pressure (e.g., 200 N) higher than that of the fixing roller 601 of the general-purpose fixing, section 600, to meet the requirements of the postcard PC which is thicker and harder than the general-purpose recording medium P.

The fixing roller 621a is provided with a cleaning web 623. The cleaning web 623 is the same as the one described with reference to FIGS. 6a-6c.

The ejection guide 624, lower-side introducing plate 625, upper side-introducing plate 626 and introducing ratchet wheel 627 are the same as those of the general-purpose fixing section 600 described with reference to FIGS. 6a-6c.

In FIG. 9, the fixing device having been replaced and accommodated in the accommodation section 170 is determined in Step S08 of FIG. 4 as the fixing section for postcards 620 (Step S08: Yes), the statuses of the peripheral member 180, the interior of the fixing section for postcards 620 and image forming apparatus 10 are switched over to the statuses suited for the fixing section for postcards 620 in the “Sub-routine for postcards” of the Step S40.

In the steps from Step S401 through Step S406, the peripheral member 180 is switched over to the statuses suited to the fixing section for postcards 620.

In the first place, in Step S401, the first air outlet 187b of the air blow member 187 is changed over to the reference position described with reference to FIG. 3.

In Step S402, the ventilation fan 187a of the air blow member 187 is suspended by the control section 150, and ventilation of the air blow member 187 is stopped. For the postcard, the end of the fixing roller 621 is less likely to be overheated by the central portion, as may be apparent from FIG. 10a. This allows unwanted cooling to be avoided by suspension of the ventilation fan 187a.

In Step S403, the lower-side incoming guide 181a is changed over to the profile wherein the central portion protrudes, as shown in FIG. 100. The position is switched over to the position farther from the sheet conveyance path of the postcard PC than the reference position described with reference to FIG. 3B.

In Step S404, the ratchet wheel guide 181c is changed over to the position closer to the sheet conveyance path of the postcard PC than the reference position described with reference to FIG. 3B. This prevents the so-called bottom rubbing wherein the postcard PC abuts on the upper-side incoming guide 181b when the postcard PC is conveyed.

In Step S405, the downstream guide member 183 is changed over to the reference space described with reference to FIG. 3B.

In Step S406, the pressure member 185 is switched over to a high nip pressure (e.g., 70 N). The postcard tends to produce a greater curl than the general recording medium P shown with reference to FIGS. 6a-6c. The nip pressure is set to a higher level to ensure proper adjustment of this curl.

In Steps S407 through S410, the interior of the fixing section for postcards 620 and image forming apparatus 10 are switched over to the statuses suited for the fixing section for postcards 620.

In Step S407, control is switched so that the “Duplex printing mode” out of the operation modes of the image forming apparatus 10 can be selected by the control section 150. This allows the “Duplex printing mode” to be selected by the operation section 400.

This is followed by the Step S408 wherein control is switched so that the “Reverse ejection mode” out of the operation modes of the image forming apparatus 10 can be selected by the control section 150. This allows the “Reverse ejection mode” to be selected by the operation section 400.

In Step S409, the fixing temperature of the fixing roller 621 is set to the standard temperature by the control section 150 so that temperature is placed under control.

In Step S410, the updating frequency of the cleaning web 623 is set to the standard frequency. To put it another way, the roll take-up speed of the cleaning web 623 is set to the standard speed. The control goes back to the “Sub-routine for postcards” of Step S40 of FIG. 4. In the aforementioned Steps, the peripheral member 180, the interior of the fixing section for postcards 620 and image fanning apparatus 10 are switched over to the statuses suited for the fixing section for postcards 620.

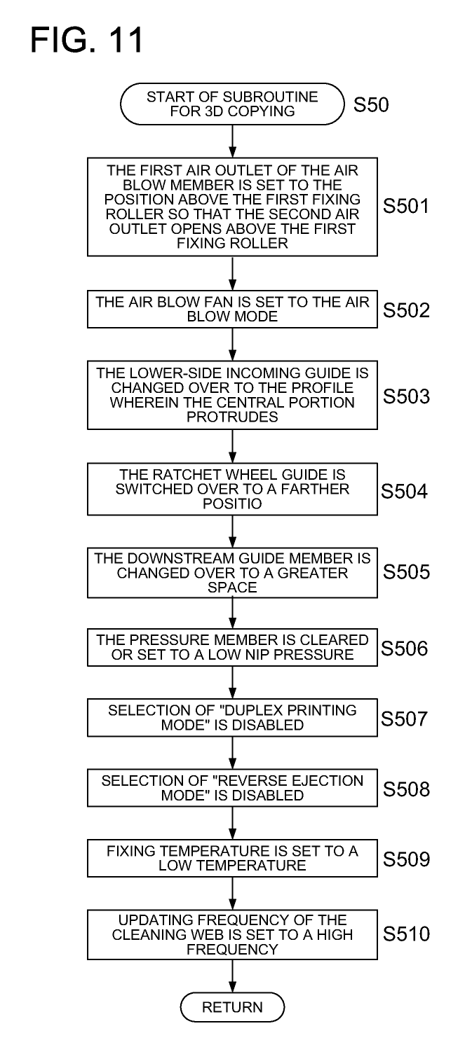

The following describes the “Sub-routine for 3D copying” of Step S50 with reference to FIG. 11 and FIGS. 12a-12c. FIG. 11 is a flow chart representing the operation of replacing the fixing device and accommodating the fixing section for 3D copying into the accommodation section. FIGS. 12a-12c are schematic diagrams showing the structure of the fixing section for 3D copying and the status of the peripheral member. FIG. 12a is a top view of the 3D copying paper as a recording medium as viewed from the printed surface. FIG. 12B is a side view of the 3D copying paper as viewed from the side, and FIG. 12c is a schematic diagram showing the profile of the lower-side incoming guide.

The following shows a brief description of 3D copying. In 3D copying, a toner image of a letter or picture is formed on a special paper coated on paper surface by a thermal expansion type micro-capsule whose volume increases about 100 times temporarily when heat is applied. The 3D copying special-purpose fixing device temporarily fixes the toner image on the special paper. The special paper is then heated by a special processing device. The thermal expansion type micro-capsule on the toner-attached portion absorbs heat and expands so that letters and images rise. Thus, the letter and picture are copied in three dimensions. This function is effective in creating a Braille document, for example.

Referring to FIG. 12, the following describes the structure of the fixing section for 3D copying 630.

In FIGS. 12a-12c, the fixing section for 3D copying 630 is a special-purpose fixing device used to fix the toner image T formed on the printed surface SPa of 3D copying paper SP as a recording medium P. The fixing section 630 includes two pairs of first fixing rollers 631 and the second fixing rollers 632, cleaning web 633, ejection guide 634, lower-side introducing plate 635, upper side-introducing plate 636 and introducing ratchet wheel 637. The specifications for the fixing section for 3D copying 630 are determined by the profile, number and layout of two pairs of first fixing rollers 631 and second fixing rollers 632.

Two pairs of first fixing rollers 631 (631a and 631b) and second fixing rollers 632 (632a and 632b) each have a length greater than the maximum length of a 3D copying paper SP on which an image can be fixed. These rollers are arranged at the center of the traveling direction (arrow mark A) of 3D copying paper SP in series perpendicular to the traveling direction (arrow mark A).

The nip pressure of the first fixing roller 631 and the second fixing roller 632 is set at a nip pressure (e.g., 115 N) which is lower than the nip pressure of the fixing roller 601 of the general-purpose fixing section 600. As will be described later, the fixing temperatures of the first fixing roller 631 and the second fixing roller 632 are set by the control section 150 at a temperature (e.g., 150 degrees Celsius) which is lower than the reference temperature (e.g., 200 degrees Celsius) used in the general-purpose fixing section 600. This low temperature control allows a toner image to be formed without adversely affecting the aforementioned thermal expansion type micro-capsule.

The first fixing roller 631a and the second fixing roller 632a located on the side of the printed surface SPa of the 3D copying paper SP are each provided with a cleaning web 633. The cleaning web 633 is the same as the cleaning web 603 described with reference to FIG. 6. As will be described later, the updating frequency thereof is set at a higher level by the control section 150 and is kept under control.

The ejection guide 634 ensures that the 3D copying paper SP on which an image has been fixed by the first fixing roller 631 and the second fixing roller 632 is ejected to the outside from the fixing section for 3D copying 630. The ejection guide 634 is made up of two plates arranged in the same wide space as that of the downstream guide member 183 to be described later.

The lower-side introducing plate 635, upper side-introducing plate 636 and introducing ratchet wheel 637 are the same as those of the general-purpose fixing section 600 described with reference to FIG. 6.

In FIG. 11, it has been determined in Step S09 of FIG. 4 that the fixing device having been replaced and accommodated into the accommodation section 170 is the fixing section for 3D copying 630 (Step S09: Yes), the peripheral member 180, the interior of the fixing section for 3D copying 630 and image forming apparatus 10 are changed over to the statuses suited for the fixing section for 3D copying 630 in the “Sub-routine for 3D copying” of Step S50.

In Steps S501 through S506, the peripheral member 180 is switched over to the statuses suited to the fixing section for 3D copying 630.

In Step S501, the first air outlet 187b of the air blow member 187 is set to the position wherein the outlet opens over both ends of the first fixing roller 631 of FIG. 12a. At the same time, the second air outlet 187c is set to the position wherein this outlet opens over both ends of the second fixing roller 632, with the result that a shutter (not illustrated) provided on the ventilation duct 187d opens. This enables ventilation on both ends of the second fixing roller 632.

In Step S502, the ventilation fan 187a of the air blow member 187 is put to the ventilation mode by the control section 150, and ventilation is applied to both ends of the first fixing roller 631 and both ends of the second fixing roller 632.

In Step S503, the lower-side incoming guide 181a is switched over to the profile wherein the central portion of FIG. 12C protrudes. At the same time, the position is changed to the reference position described with reference to FIG. 3.

In Step S504, the ratchet wheel guide 181c is switched over to the position farther from the sheet conveyance path of the 3D copying paper SP than the reference position described with reference to FIG. 3B. This prevents the toner image Ton the 3D copying paper SP from being scratched by the ratchet wheel guide 181c when the 3D copying paper SP is conveyed.

In Step S505, the downstream guide member 183 is switched over to the space greater than the reference space described with reference to FIG. 3B. This reduces the possibility of 3D copying paper SP being brought in contact with the downstream guide member 183, and prevents the surface of the 3D copying paper SP from being damaged when, the 3D copying paper SP is conveyed.

In Step S506, the nip of the pressure member 185 is cleared or set to a low nip pressure (e.g., 25 N). This protects the thermal expansion type micro-capsule on the 3D copying paper SP against possible adverse effects.

In Steps S507 through S510, the interior of the fixing section for 3D copying 630 and image forming apparatus 10 are set to the statuses suited for the fixing section for 3D copying 630.

In Step S507, control is set by the control section 150 to disable selection of the “Duplex printing mode” out of the operation modes of the image forming apparatus 10. This disables selection of the “Duplex printing mode” by the operation section 400. At the same time, the control section 150 allows the display section 300 to notify that selection of the “Duplex printing mode” is disabled, for example.

This is followed by the Step S508 wherein control is provided by the control section 150 to disable selection of the “Reverse ejection mode” out of the operation modes of the image forming apparatus 10. This disables the selection of the “Reverse ejection mode” by the operation section 400. At the same time, the control section 150 allows the display section 300 to notify that selection of the “Reverse ejection mode” is disabled, for example.

In Step S509, control is provided by the control section 150 to ensure that the fixing temperatures of the first fixing roller 631 and the second fixing roller 632 are set to the temperature (e.g., 150 degrees Celsius) lower than the reference temperature of the general-purpose fixing section 600 (e.g., 200 degrees Celsius). This temperature is kept under control.

In Step S510, the updating frequency of the cleaning web 633 is set to a high frequency. To put it another way, the roll take-up speed of the cleaning web 633 is set to a high speed. This effectively removes the toner that would be deposited in a greater amount than usual on the fixing roller under low temperature control. Upon termination of the aforementioned steps, the control goes back to the “Sub-routine for 3D copying” of Step S50 of FIG. 4. The aforementioned Steps ensure that the peripheral member 180, the interior of the fixing section for 3D copying 630 and image forming apparatus 10 are set to the statuses suited for the fixing section for 3D copying 630.

Referring to FIGS. 13a-13e and FIGS. 14a-14c, the following describes an example of the profile of the peripheral member, and profile/position switching procedure by the link mechanism. FIGS. 13a-13c are schematic diagrams showing an example of the method for switching the lower-side incoming guide profile by the link mechanism. FIG. 13a is a top view before the profile is switched. FIG. 13B is a side view before the profile is switched, and FIG. 13c is a side view after the profile has been switched.

In FIG. 13a and FIG. 13B, the lower-side incoming guide 181a consists of two guide plates LP and RP connected by a shaft at a joint portion JT. The end of the guide plate RP is provided with an engagement section PJ.

A coil spring and others are built in the joint portion JT of the lower-side incoming guide 181a. With the joint portion JT positioned at center, bias is applied in such a way that the joint portion JT is convexed upward in the drawing. In the drawing, this biasing force is schematically shown as a virtual spring SP.

The leading edge LPE of the guide plate LP is fixed on an accommodation section 170 (not illustrated) by the stationary portion BS provided on the accommodation section 170 (not illustrated).

Assume that the fixing section for envelopes 610 is mounted on the accommodation section 170 (not illustrated) in the direction of arrow mark R. A type determining plate 619 is mounted on the fixing section for envelopes 610, as shown in FIG. 2c.

In FIG. 13c, when the fixing section for envelopes 610 is mounted in the direction of arrow mark R, the type determining plate 619 is connected to the engagement section PJ on the end of the guide plate RP, and the guide plate RP is moved in the direction of arrow mark R through the engagement section PJ against the biasing force of the virtual spring SP.

As a result, the joint portion JT is pushed downward in the drawing, and the lower-side incoming guide 181a assumes the same flat profile as illustrated in FIG. 3d. Thus, the profile of the lower-side incoming guide is switched by the link mechanism.

FIGS. 14a-14c are schematic diagrams showing another example of the method for switching the lower-side incoming guide profile by the link mechanism. FIG. 13a is a perspective view before the profile is switched. FIG. 13B is a side view before the profile is switched, and FIG. 13c is a side view after the profile is switched.

In FIG. 14a and FIG. 14B, the lower-side incoming guide 181a is composed of a stationary guide plate PL1 and movable guide plate PL2. The stationary guide plate PL1 is an L-shaped stationary plate, and the upper surface PL11 thereof is a plane surface. The movable guide plate PL2 is rotatably mounted on the periphery of the drive shaft SH, and the surface thereof assumes the profile wherein the curved portion PL21 and plane surface portion PL22 are connected.

An engagement section PJ is installed on one end of the drive shaft SH. A bias is applied to the engagement section PJ by a spring SP in the upward direction of the drawing. The engagement section PJ is engaged with a rotation stopper ST fixed to the accommodation section 170 (not illustrated) to ensure that the engagement section PJ will not rotate upwardly of the horizontal line.

As shown in FIG. 14B, before the profile is switched, both ends of the lower-side incoming guide 181a are made into a plane surface by the upper surface PL11 of the stationary guide plate PL1. In the central portion of the lower-side incoming guide 181a, the curved portion PL21 of the movable guide plate PL2 protrudes from the upper surface PL11 of the stationary guide plate PL1. Because of this arrangement, the central portion of the lower-side incoming guide 181a is convexed.

Assume that the fixing section for envelopes 610 is mounted on the accommodation section 170 (not illustrated) in the direction of arrow mark R. Here, the type determining plate 619 installed on the fixing section for envelopes 610 is designed in the shape of a wedge. As the fixing section for envelopes 610 moves in the direction of arrow mark R, the engagement section PJ is rotated downward and the drive shaft SH is rotated in the counterclockwise direction of the drawing.

Because of this arrangement, the central portion of the lower-side incoming guide 181a is switched from the curved portion PL21 of the movable guide plate PL2 over to the plane surface portion PL22, as shown in FIG. 14c. The lower-side incoming guide 181a turns into a plane profile having the same height as that of the upper surface PL11 of the stationary guide plate PL1. Thus, the lower-side incoming guide profile is switched by the link mechanism.

As described above, one embodiment of the present invention provides an image forming apparatus and image forming system equipped with an accommodation section and peripheral members arranged around the accommodation section, wherein the accommodation section is capable of replacing and accommodating a plurality of fixing devices such as a general-purpose fixing section, fixing section for envelopes, fixing section for postcards and fixing section for 3D copying; and, if a fixing device accommodated in the accommodation section has been replaced, the statuses of the peripheral member, the interior of the replaced fixing device and image forming apparatus are switched in conformity to the specifications of the replaced fixing device, thereby making maximum use of the characteristics of the replaced fixing device and enhancing the fixing device replacement efficiency.

As described above, another embodiment of the present invention provides an image forming apparatus and image forming system including: a first fixing device for fixing a toner image; an accommodation section for accommodating the first fixing device; and peripheral members arranged around the accommodation section; wherein the accommodation section is capable of replacing and accommodating the first fixing device and a second fixing device having different specifications from those of the first fixing device, and, when the first fixing device accommodated in the accommodation section has been replaced by the second fixing device, the status of the peripheral member is switched in conformity to the specifications of the second fixing device, thereby making maximum use of the characteristics of the special-purpose fixing device and improving the fixing device replacement efficiency.

A further embodiment of the present invention provides an image forming apparatus and image forming system including: a first fixing device for fixing a toner image; and an accommodation section for accommodating the first fixing device; wherein the accommodation section is capable of replacing and accommodating the first fixing device and a second fixing device having different specifications from those of the first fixing device, and a control section is provided to control the operation status of the image forming apparatus in conformity to the specifications of the second fixing device, when the first fixing device accommodated in the accommodation section has been replaced by the second fixing device, thereby making maximum use of the characteristics of the special-purpose fixing device and improving the fixing device replacement efficiency.

It is to be expressly understood, however, that the detailed structures and operations of the components constituting the image forming apparatus and image forming system of the present invention can be embodied in a great number of variations with appropriate modifications or additions, without departing from the technological spirit of the invention.

What is claimed is:

1. An image forming apparatus comprising:
an image formation section for forming a toner image based on image data on a recording medium;
a first fixing device for fixing the toner image formed by the image formation section;
an accommodation section for storing the first fixing device or a second fixing device having different specifications than those of the first fixing device; and
a peripheral member arranged on a periphery of the accommodation section to operate synchronously with the first fixing device or second fixing device;
wherein, when the first fixing device accommodated in the accommodation section has been replaced by the second fixing device, a status of the peripheral member is switched in conformity to specifications of the second fixing device.

2. The image forming apparatus of claim 1, wherein the first fixing device and the second fixing device each have a fixing roller, and specifications of the first fixing device and the specifications of the second fixing device are determined by a profile, number and layout of the fixing rollers.

3. The image forming apparatus of claim 2, wherein the peripheral member is any one of an air blow member for blowing air to the fixing roller; an upstream guide member arranged upstream of the first fixing device in a direction of conveying the recording medium for guiding the recording medium to the first fixing device from the image formation section; a downstream guide member arranged downstream of the first fixing device in the direction of conveying the recording medium for guiding the recording medium conveyed from the first fixing device; and a pressure member arranged downstream of the first fixing device in the direction of conveying the recording medium for applying pressure to the recording medium fed from the first fixing device.

4. The image forming apparatus of claim 3, wherein the peripheral member is the upstream guide member, and at least one of a position or profile of the upstream guide member is switched in conformity to the specifications of the second fixing device, when the first fixing device accommodated in the accommodation section has been replaced by the second fixing device.

5. The image forming apparatus of claim 4, wherein the upstream guide member is a lower-side incoming guide for supporting the recording medium from a lower side of the recording medium, and, when the first fixing device accommodated in the accommodation section has been replaced by the second fixing device, a profile of the lower-side incoming guide is switched to either a profile protruding in a direction perpendicular to a printed surface of the recording medium or a flat profile at the central portion of the lower-side incoming guide in conformity to the specifications of the second fixing device.

6. The image forming apparatus of claim 3, wherein the peripheral member is the air blow member, and, when the first fixing device accommodated in the accommodation section has been replaced by the second fixing device, either the position or profile of the air blow member is switched to blow air to the fixing roller of the second fixing device in conformity to the specifications of the second fixing device.

7. The image forming apparatus of claim 3, wherein the peripheral member is the pressure member, and, when the first fixing device accommodated in the accommodation section has been replaced by the second fixing device, a nip pressure of the pressure member for applying pressure to the recording medium is switched in conformity to the specifications of the second fixing device.

8. The image forming apparatus of claim 3, wherein the peripheral member is the downstream guide member, and the downstream guide member includes a first downstream guide member for guiding the recording medium conveyed from the first fixing device so as to hold the recording medium inside; and a second downstream guide member;
wherein, when the first fixing device accommodated in the accommodation section has been replaced by the second fixing device, the distance between the first downstream guide member and the second downstream guide member is switched in conformity to the specifications of the second fixing device.

9. The image forming apparatus of claim 1, further comprising a control section to provide control in such a way that, when the first fixing device accommodated in the accommodation section has been replaced by the second fixing device, the operation status of the image forming apparatus is controlled in conformity to the specifications of the second fixing device.

10. The image forming apparatus of claim 9, further comprising a blowing fan for blowing air to the fixing roller, and, when the first fixing device accommodated in the accommodation section has been replaced by the second fixing device, the control section provides control to switch the operation status of the blowing fan in conformity to the specifications of the second fixing device.

11. The image forming apparatus of claim 9, wherein when the first fixing device accommodated in the accommodation section has been replaced by the second fixing device, the control section controls an amount of heat energy to be applied to the fixing roller of the second fixing device in conformity to the specifications of the second fixing device.

12. The image forming apparatus of claim 9, wherein when the first fixing device accommodated in the accommodation section has been replaced by the second fixing device, the control section controls a frequency of replacing a cleaning web for cleaning the fixing roller of the second fixing device in conformity to the specifications of the second fixing device.

13. The image forming apparatus of claim 9, further comprising a selecting section for selecting at least one of a reversing mode for reversing and conveying a recording medium and a duplex printing mode for forming a toner image on both sides of the recording medium, wherein, when the first fixing device accommodated in the accommodation section has been replaced by the second fixing device, the control section controls the selecting section to disable selection of the reversing mode or duplex printing mode in conformity to the specifications of the second fixing device.

14. The image forming apparatus of claim 1, further comprising a detecting section for detecting that the first fixing device accommodated in the accommodation section has been replaced by the second fixing device.

15. An image forming apparatus comprising:
an image formation section for forming a toner image based on image data on a recording medium;
a first fixing device for fixing the toner image formed by the image formation section;
an accommodation section for storing the first fixing device or a second fixing device having different specifications than those of the first fixing device; and
a control section to provide control in such a way that, when the first fixing device accommodated in the accommodation section has been replaced by the second fixing device, an operation status of the image forming apparatus is controlled in conformity to the specifications of the second fixing device.

16. The image forming apparatus of claim 15, wherein the first fixing device and the second fixing device each have a fixing roller, and specifications of the first fixing device and the specifications of the second fixing device are determined by a profile, number and layout of the fixing rollers.

17. The image forming apparatus of claim 16, further comprising a blowing fan for blowing air to the fixing roller, and, when the first fixing device accommodated in the accommodation section has been replaced by the second fixing device, the control section provides control to switch the operation status of the blowing fan in conformity to the specifications of the second fixing device.

18. The image forming apparatus of claim 16, wherein when the first fixing device accommodated in the accommodation section has been replaced by the second fixing device, the control section controls an amount of heat energy to be applied to the fixing roller of the second fixing device in conformity to the specifications of the second fixing device.

19. The image forming apparatus of claim 16, wherein when the first fixing device accommodated in the accommodation section has been replaced by the second fixing device, the control section controls a frequency of replacing a cleaning web for cleaning the fixing roller of the second fixing device in conformity to the specifications of the second fixing device.

20. The image forming apparatus of claim 15, further comprising a selecting section for selecting at least one of a reversing mode for reversing and conveying a recording medium and a duplex printing mode for forming a toner image on both sides of the recording medium, wherein, when the first fixing device accommodated in the accommodation section has been replaced by the second fixing device, the control section controls the selecting section to disable selection of the reversing mode or duplex printing mode in conformity to the specifications of the second fixing device.

21. The image forming apparatus of claim 15, further comprising a detecting section for detecting that the first fixing device accommodated in the accommodation section has been replaced by the second fixing device.

22. An image forming system comprising:
an image forming apparatus including an image formation section for forming a toner image based on image data on a recording medium; a first fixing device for fixing the toner image formed by the image formation section; an accommodation section for storing the first fixing device; and a peripheral member arranged on the periphery of the accommodation section; and
a second fixing device for fixing the toner image formed by the image formation section, wherein the specifications of the second fixing device are different from those of the first fixing device;
wherein the accommodation section is configured to accommodate the first fixing device and the second fixing device interchangeably and wherein, when the first fixing device accommodated in the accommodation section has been replaced by the second fixing device, a status of the peripheral member is switched in conformity to specifications of the second fixing device.

23. An image forming system comprising:
an image forming apparatus including: an image formation section for forming a toner image based on image data on a recording medium; a first fixing device for fixing the toner image formed by the image formation section; an accommodation section for storing the first fixing device; and a peripheral member arranged on the periphery of the accommodation section; and
a second fixing device for fixing the toner image formed by the image formation section, wherein the specifications of the second fixing device are different from those of the first fixing device;
wherein the accommodation section is configured to accommodate the first fixing device and the second fixing device interchangeably and wherein, when the first fixing device accommodated in the accommodation section has been replaced by the second fixing device, an operation status of the image forming apparatus is controlled in conformity to the specifications of the second fixing device.
